(19) United States
(12) Patent Application Publication
(10) Pub. No.: US 2025/0301096 A1
(43) Pub. Date: Sep. 25, 2025

(54) INFORMATION PROCESSING SYSTEM, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventors: Mami YOKOHASHI, Kanagawa (JP); Toshihiro IWAFUCHI, Kanagawa (JP); Kaoru YAMAUCHI, Kanagawa (JP); Masahiko KUBO, Kanagawa (JP)

(73) Assignee: FUJIFILM Business Innovation Corp., Tokyo (JP)

(21) Appl. No.: 18/761,343

(22) Filed: Jul. 2, 2024

(30) Foreign Application Priority Data
Mar. 21, 2024 (JP) 2024-045738

(51) Int. Cl. H04N 1/60; H04N 1/50

(52) U.S. Cl. CPC H04N 1/603; H04N 1/50; H04N 1/6022

(57) ABSTRACT

An information processing system includes a processor configured to generate profile data in which, in a case of generating the profile data for converting input color values into colorant amounts to be used for printing, in a case where the color values to be converted are out of a color gamut that is expressible by CMYK colors which are basic colors and are within a color gamut that is expressible by a special color other than the basic colors and the basic colors, a colorant amount of each color is determined such that a colorant amount of a colorant of a K color is zero.

### CROSS-REFERENCE TO RELATED APPLICATIONS

This application is based on and claims priority under 35 USC 119 from Japanese Patent Application No. 2024-045738 filed Mar. 21, 2024.

### BACKGROUND

### (i) Technical Field

The present disclosure relates to an information processing system, a non-transitory computer readable medium storing a program, and an information processing method.

### (ii) Related Art

JP2007-194745A discloses a color processing apparatus that sets a color gamut corresponding to characteristic components for an input-side color signal, generates a color signal pair in which the input-side color signal and each of the characteristic components are associated with each other within the color gamut, calculates each of the characteristic components corresponding to a color signal to be converted based on the color signal pair, and calculates a main color component from the calculated characteristic components and the color signal to be converted to obtain a conversion output color signal by using the main color component and the characteristic components.

JP2011-010083A discloses a color processing apparatus that selects a combination of values of M color components, which is a combination of values of M color components in which the sum of the values of M color components is a minimum, among combinations of the values of M color components with which a target color is obtained, and which satisfies a preset restriction, acquires a combination of values of M color components, which is obtained by changing the combination of values of M color components within a range satisfying the restriction, for the selected combination of values of M color components, and increases or decreases the number of the obtained combinations of M color components according to a color gamut to obtain a set of color samples.

### SUMMARY

In a printing device that prints an image on a recording medium, colors of an image to be formed change due to characteristics of the recording medium, environmental conditions, characteristics of the printing device, and the like. Therefore, profile data for converting the color values obtained by printing the color measurement chart having a plurality of patch images by a printing device, and color-measuring the plurality of patch images in the color measurement chart respectively into colorant amounts used for printing is generated in advance. In the printing process by the printing device, the printing is executed by determining the colorant amount of each color in a case of printing using the generated profile data.

In recent years, in order to expand a color gamut of an image to be printed by a printing device, printing has been performed by using colorants of basic colors called CMYK color and colorants of special colors such as fluorescent pink (hereinafter, referred to as P) and fluorescent green (hereinafter, referred to as G). By using such colorants of special colors, a vivid color can be reproduced, and the color gamut is expanded. However, an image printed using a colorant of K color (black color) has generally poorer graininess as compared with an image printed using only colorants of CMY colors. In particular, in a case of an image printed using a bright colorant such as a fluorescent color, in a case of being combined with a K colorant, deterioration in graininess due to the K colorant is more noticeable compared to an image printed using CMY colorants.

Aspects of non-limiting embodiments of the present disclosure relate to an information processing system, a non-transitory computer readable medium storing a program, and an information processing method that can reduce deterioration in graininess of an image to be printed, in a case of generating profile data for a printing device using a colorant of a special color other than CMYK colors which are basic colors, as compared with a case of uniformly determining the colorant amount of colorants of the basic colors and the colorant of the special color corresponding to the color values regardless of the color values to be converted.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including: a processor configured to: generate profile data in which, in a case of generating the profile data for converting input color values into colorant amounts to be used for printing, in a case where the color values to be converted are out of a color gamut that is expressible by CMYK colors which are basic colors and are within a color gamut that is expressible by a special color other than the basic colors and the basic colors, a colorant amount of each color is determined such that a colorant amount of a colorant of a K color is zero.

### BRIEF DESCRIPTION OF THE DRAWINGS

Exemplary embodiment(s) of the present invention will be described in detail based on the following figures, wherein:

FIG. 1 is a diagram showing a system configuration of an image forming system according to an exemplary embodiment of the present disclosure;

FIG. 2 is a cross-sectional view showing a structure of an image forming apparatus 20 shown in FIG. 1;

FIG. 3 is a diagram showing a difference in image quality depending on a combination of the amounts of toners in a case where the same color is reproduced;

FIG. 4 is a diagram showing a hardware configuration of a terminal apparatus 10 in the image forming system according to the exemplary embodiment of the present disclosure;

FIG. 5 is a block diagram showing a functional configuration of the terminal apparatus 10 in the image forming system according to the exemplary embodiment of the present disclosure;

FIG. 6 is a diagram showing a state where an ICC profile generation unit 32 generates an ICC profile in which the toner amounts of CMYKP colors are determined such that the amount of a K toner is zero in a case where Lab values to be converted are out of a color gamut that can be expressed by the CMYK colors which are basic colors;

FIG. 7 is a diagram showing a setting screen example in a case where a generation condition reception unit 31 receives the generation condition of the ICC profile;

FIG. 8 is a flowchart for describing the overall operation of an ICC profile generation process in the ICC profile generation unit 32;

FIG. 9 is a flowchart for describing details of a process of step S103 described in the flowchart of FIG. 8;

FIG. 10 is a diagram showing a determination method in a case where the amounts of the K toner and a P toner are determined in a case where the Lab values to be converted are within the range of the color gamut that is expressible by the CMYK colors; and

FIG. 11 is a diagram showing a determination method in a case where the amounts of the K toner and the P toner are determined in a case where the Lab values to be converted are out of the range of the color gamut that is expressible by the CMYK colors.

### DETAILED DESCRIPTION

Hereinafter, an exemplary embodiment of the present disclosure will be described in detail with reference to the drawings.

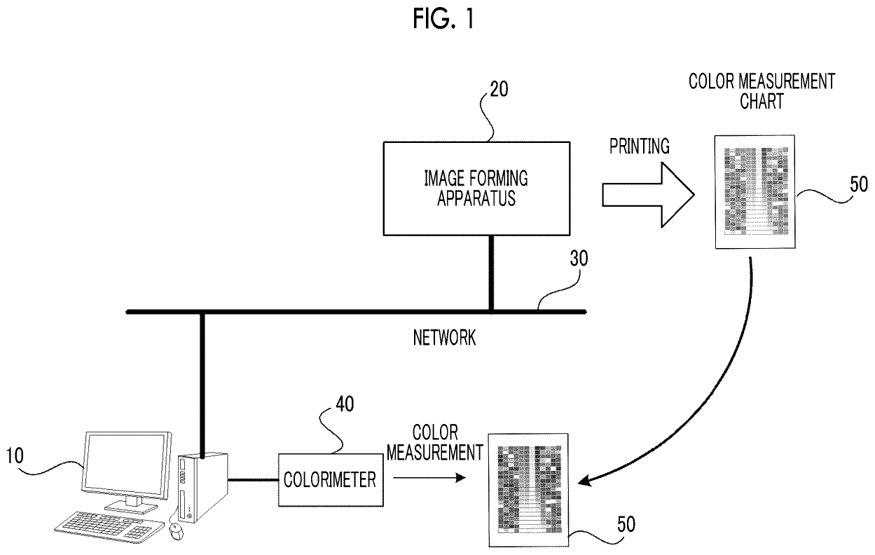

FIG. 1 is a diagram showing a system configuration of an image forming system according to an exemplary embodiment of the present disclosure.

As shown in FIG. 1, an image forming system according to the present exemplary embodiment includes an image forming apparatus 20 and a terminal apparatus 10 that are connected to each other via a network 30, and a colorimeter 40 connected to the terminal apparatus 10. The image forming apparatus 20 is, for example, a so-called production printer used for printing for business use, and has a function of being capable of executing a high-speed printing process with high image quality.

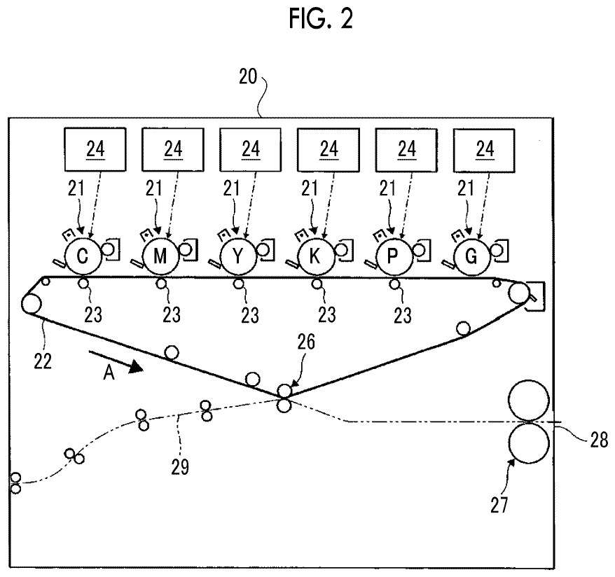

Next, a structure of the image forming apparatus 20 shown in FIG. 1 is shown in FIG. 2.

As shown in FIG. 2, the image forming apparatus 20 includes six image forming units 21. The six image forming units 21 are configured to form an image on a recording medium by using basic color toners of yellow (Y), magenta (M), cyan (C), and black (K) and two special color (fluorescent pink (P) and fluorescent green (G)) toners.

The image forming unit 21 is configured with a photosensitive drum, a charging device that uniformly charges a surface of the photosensitive drum, a developing device that develops the electrostatic latent image formed on the photosensitive drum, and a cleaning device. The photosensitive drum is a cylindrical image holder that holds a toner image (developer image), and is uniformly charged by the charging device. An electrostatic latent image is formed thereon with laser light emitted by an optical scanning device 24. The electrostatic latent image formed on the photosensitive drum is developed with a toner from the developing device and is transferred to an intermediate transfer belt 22. Residual toners, paper dust, and the like adhered to the photosensitive drum after a toner image transfer step are removed by the cleaning device.

The image forming unit 21 is provided close to the intermediate transfer belt 22. The intermediate transfer belt 22 is configured to be rotationally movable in a direction of an arrow A in FIG. 2. Each primary transfer roll 23 is disposed at a position facing the photosensitive drum with the intermediate transfer belt 22 interposed therebetween. The primary transfer roll 23 is provided to transfer the toner image of each color formed on the photosensitive drum to the intermediate transfer belt 22.

A transport path 29 for transporting the recording medium is formed below the intermediate transfer belt 22. A plurality of transport rolls that transport the recording medium from a carrying-in port 25 to a discharge port 28 are provided in the transport path 29. In addition, in the transport path 29, a secondary transfer device 26 that performs secondary transfer of the toner image primary-transferred from the photosensitive drum to the intermediate transfer belt 22 to the recording medium transported in the transport path 29 is provided. A fixing device 27 is provided on the downstream side of the recording medium transport direction of the secondary transfer device 26. The fixing device 27 is a device for fixing the image formed by the plurality of image forming units 21 on the recording medium by heating the image, and fixes the image of the recording medium to which the toner image is transferred to the recording medium by heat and pressure. The recording medium on which the image has been fixed by the fixing device 27 is discharged from the discharge port 28.

Here, in the image forming apparatus 20 that prints an image on a printing paper, the color of the printed image varies due to the characteristics of the printing paper, the environmental conditions, the individual differences of the image forming apparatus 20, and the like. Therefore, in order to maintain the consistency of the color between the printing papers and to unify the color reproduction between the models, conversion data called an International Color Consortium (ICC) profile is generated in advance for each model, and the toner amount of each color in a case of printing is determined based on this ICC profile.

Here, the color value that does not depend on the device characteristics is generally expressed by a color space called L*a*b* defined by the International Commission on Illumination (CIE). In the following description, the values in the L*a*b* color space will be simply described as Lab values. Therefore, in order to reproduce the Lab color values expressed in a certain Lab color space, an ICC profile is profile data that holds information in the form of a lookup table regarding which color toners are combined with what amounts to perform the printing process.

In a case of generating such an ICC profile, first, the image forming apparatus 20 prints a color measurement chart 50 configured with a plurality of patch images. Then, the color value of each patch image of the printed color measurement chart 50 is color-measured by a colorimeter 40, and the color value is input to the terminal apparatus 10. Then, the terminal apparatus 10 generates an ICC profile by determining a combination of the toner amounts such that the input color values become target color values, and stores the generated ICC profile in the image forming apparatus 20. Then, the image forming apparatus 20 determines the amount of each color toner in a case of printing using the stored ICC profile and executes the printing process, so that the color values of the printed image approach the target color values. Here, the input color values are Lab color values to be input. However, the ICC profile may include CMYK color values or RGB color values, and the color values are not limited to the Lab color values. In addition, the target color values are color values obtained by converting the input color values into Lab color values that can be output by the printer. Furthermore, the combination of toner amounts refers to the CMYK color values capable of reproducing the target color values calculated from a pair of the CMYK of the patch and the Lab color values color-measured.

As described above, the image forming apparatus 20 performs printing by using toners of two special colors of PG in addition to toners of normal colors of CMYK, so the terminal apparatus 10 needs to generate an ICC profile for determining the amounts to be used for the normal color toners and special color toners in order to reproduce certain Lab values.

However, it is not possible to uniquely determine an ICC profile for converting three-dimensional data which is Lab values into five-dimensional data which is CMYKPG. Further, even in a case where the reproduced Lab values are the same, the image quality of the printed image changes depending on the amount of the K toner and the amounts of the special color toners PG, so it is necessary to determine an appropriate combination from a huge number of combinations of the color toner amounts of the CMYKPG toners.

Here, the ratio of the amount of toner that is actually used to the amount of the special color toner required for reproducing certain Lab values is referred to as a chromatic component replacement (CCR) rate. Similarly, a ratio of the toner amount to be actually used to the amount of the K toner required for reproducing certain Lab values is referred to as a gray component replacement (GCR) rate.

For example, in the following description, for the sake of simplicity of description, a case where printing is performed using a P (fluorescent pink) toner as a special color toner in addition to CMYK toners of normal colors will be described.

Even in a case where the special color toner is a one color toner of the P toner, in order to determine the ICC profile, it is necessary to determine the toner amounts of a total of five colors by using the P color in addition to the four colors of CMYK in order to reproduce certain Lab values. Therefore, the amount of the P toner is determined based on a preset CCR rate, and the amount of the K toner is determined based on a preset GCR rate. In a case where the toner amounts of the remaining CMY three colors are determined after the amounts of the K toner and the P toner are determined, the solution for converting the Lab values which are three-dimensional data into CMY values which are three-dimensional data is uniquely determined.

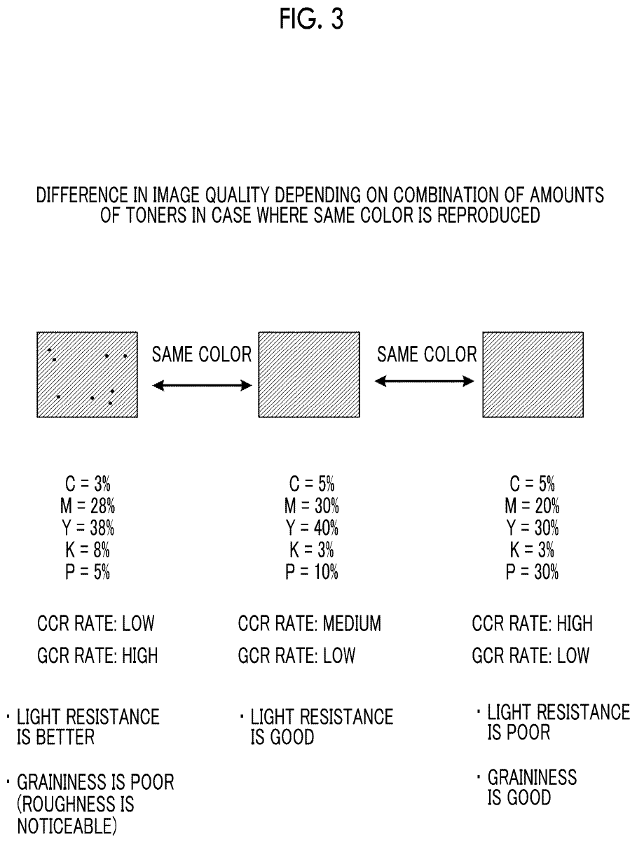

However, even in a case where the same color with the same Lab values is reproduced, there is a difference in the quality of the printed image depending on the combination of toner amounts of the toners of the respective colors. FIG. 3 shows a difference in image quality depending on a combination of the amounts of toners in a case where the same color is reproduced. FIG. 3 shows a combination example of the toner amounts of CMYKP toners in a case of reproducing the same color image of pink using the P toner.

Here, an image printed using a K toner generally has poor graininess compared to an image printed using only CMY toners. In particular, in an image printed using a P toner or the like, which is a bright colorant such as a fluorescent color, the deterioration in graininess due to K toner is more noticeable compared to an image printed using only the CMY toners. Further, the fluorescent toner such as the P toner has a characteristic that the light resistance is poor as compared with the CMYK toners which are normal colors. Here, an image having poor graininess refers to an image in which the printed image has noticeable roughness and an image in which the surface is not smooth.

Therefore, as shown in FIG. 3, in a case where the CCR rate is set to high and the GCR rate is set to low to reduce the amount of the K toner and increase the amount of the P toner, an image having good graininess can be obtained, but the light resistance is deteriorated. In addition, in a case where the CCR rate is set to an intermediate value in a state where the GCR rate is maintained as it is and the amount of the K toner is maintained as it is and the amount of the P toner is reduced, the light resistance is improved. Further, in a case where the CCR rate is set to low and the GCR rate is set to high to increase the amount of the K toner and reduce the amount of the P toner, the light resistance is good, but the image has poor graininess.

Therefore, since the terminal apparatus 10 according to the present exemplary embodiment generates the ICC profile by a method described below, in a case of generating the ICC profile data of the image forming apparatus 20 using the special color toners such as the P toner other than the CMYK colors which are the basic colors, the deterioration of the graininess of the printed image is reduced, compared to a case of uniformly determining the toner amounts of the CMYK colors and the P toner corresponding to the color values regardless of the color values to be converted.

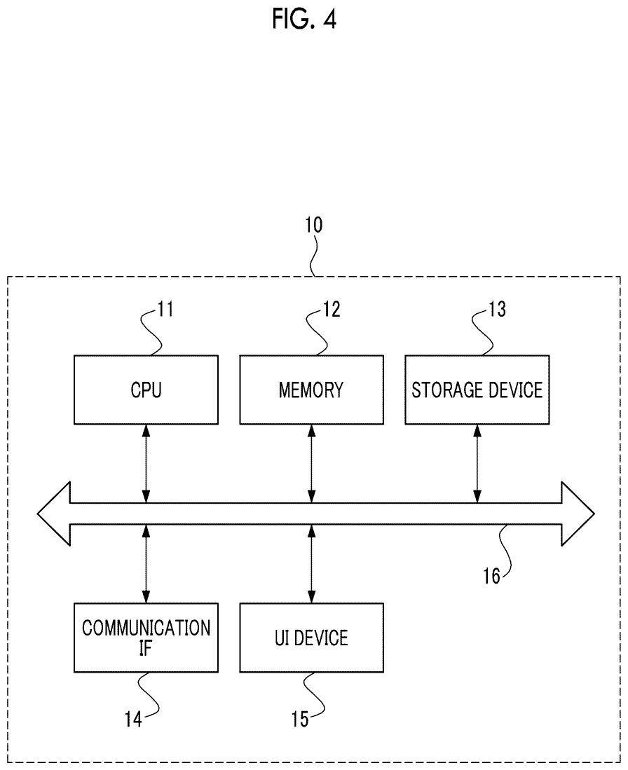

Next, a hardware configuration of the terminal apparatus 10 in the image forming system of the present exemplary embodiment is shown in FIG. 4.

As shown in FIG. 4, the terminal apparatus 10 includes a CPU 11, a memory 12, a storage device 13 such as a hard disk drive, a communication interface (IF) 14 for transmitting and receiving data to and from external devices via the network 30, and a user interface (UI) device 15 including a touch panel or a liquid crystal display and a keyboard. These constituents are connected to each other via a control bus 16.

The CPU 11 is a processor that controls the operation of the terminal apparatus 10 by executing a predetermined process based on a control program stored in the memory 12 or the storage device 13. In the present exemplary embodiment, the description has been made in which the CPU 11 reads out and executes the control program stored in the memory 12 or the storage device 13, but the present disclosure is not limited thereto. The control program may be provided in a form recorded on a computer readable recording medium. For example, the program may be provided in a form of being recorded on an optical disk such as a compact disc (CD)-ROM and a digital versatile disc (DVD)-ROM, or in a form of being recorded on a semiconductor memory such as a universal serial bus (USB) memory and a memory card. Further, the control program may be acquired from an external device via a communication line connected to the communication interface 14. Further, the control program may be provided, for example, as single application software or may be incorporated, as one function of the terminal apparatus 10, in software of each apparatus.

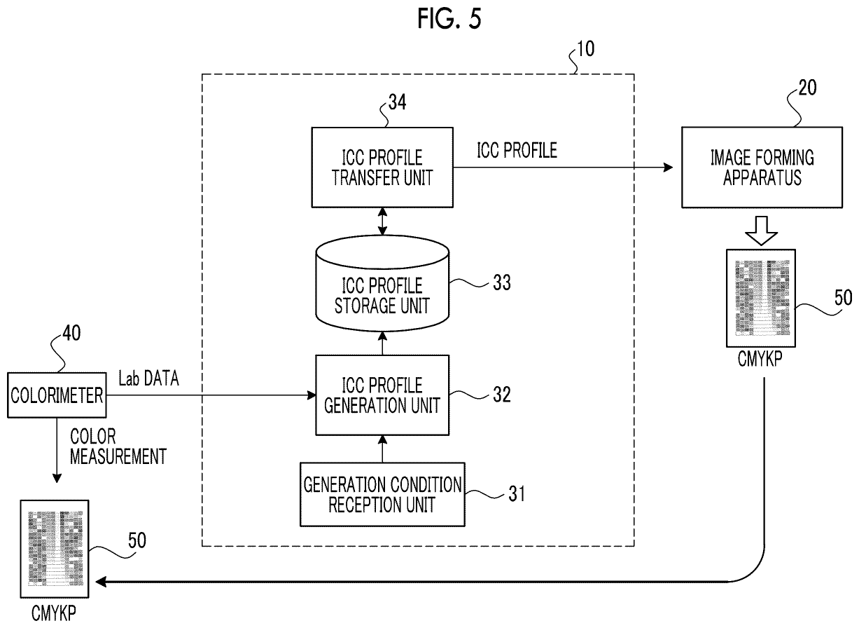

FIG. 5 is a block diagram showing a functional configuration of the mobile terminal apparatus 10 realized by executing the above control program.

As shown in FIG. 5, the terminal apparatus 10 according to the present exemplary embodiment includes a generation condition reception unit 31, an ICC profile generation unit 32, an ICC profile storage unit 33, and an ICC profile transfer unit 34. In FIG. 4, only a part related to the generation of the ICC profile in the functional configuration of the terminal apparatus 10 is shown.

The generation condition reception unit 31 receives various conditions in a case of generating the ICC profile, specifically, information such as a CCR rate and a GCR rate.

The ICC profile generation unit 32 generates an ICC profile based on the color measurement values of the patch images of the color measurement chart 50 color-measured by the colorimeter 40 and the generation conditions received by a generation condition reception unit 31, and stores the ICC profile in an ICC profile storage unit 33.

Specifically, in a case of generating an ICC profile for converting the input color values of the color measurement chart 50 into the amounts of toners to be used for printing, in a case where the Lab values to be converted are out of a color gamut that can be expressed by the CMYK colors, which are the basic colors and is within a color gamut that can be expressed by the special color P and the CMYK colors, the ICC profile generation unit 32 generates an ICC profile in which toner amounts of the CMYKP colors are determined such that the toner amount of the K color is zero.

Moreover, the ICC profile generation unit 32 determines the amount of the P toner, based on a CCR rate, which is preset rate information indicating a ratio of using the toner amount of the P color which is the special color.

Here, the ICC profile generation unit 32 determines the colorant amount of each color without setting both the colorants of the special color and the K color to zero, in a case where the color values to be converted is within the color gamut that is expressible by the CMYK colors which are the basic colors.

Specifically, the ICC profile generation unit 32 determines the amount of the P toner based on the CCR rate, and determines the amount of the K toner based on the GCR rate, which is the rate information indicating the ratio of using the preset amount of K color toner.

Then, after the toner amounts of the P toner and K toner are determined by the method described above, the ICC profile generation unit 32 determines the toner amounts of the remaining CMY toners except for the determined amounts of the K toner and the P toner, and determines the toner amounts of the CMYK toners and the P toner corresponding to the Lab values.

The ICC profile transfer unit 34 transfers the ICC profile stored in the ICC profile storage unit 33 to the image forming apparatus 20.

In the present exemplary embodiment, a case where the colorant of the special color is a fluorescent color P toner is described as an example, but an ICC profile can be generated by the same method even in a case where the colorant of the special color is a fluorescent color G toner.

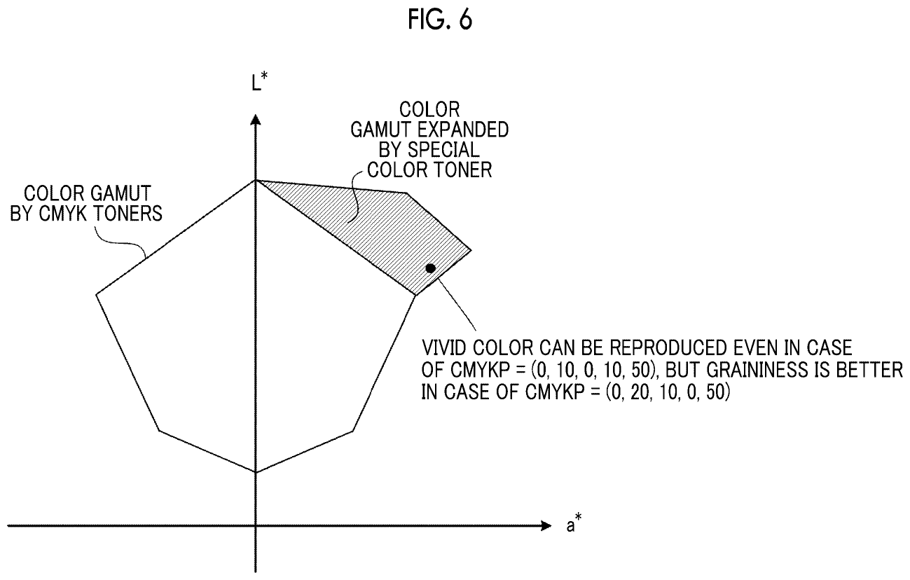

Next, FIG. 6 shows a state where an ICC profile generation unit 32 generates an ICC profile in which the toner amounts of CMYKP colors are determined such that the amount of the K toner is zero in a case where Lab values to be converted are out of a color gamut that can be expressed by the CMYK colors which are basic colors;

With reference to FIG. 6, a state in which the color gamut that can be expressed by the CMYK toners is expanded by using the basic color toners is shown. The region indicated by oblique lines in FIG. 6 indicates a color gamut that is expanded by the special color toner. In a case where the Lab values to be converted are included in the color gamut expanded by such a special color toner, the ICC profile generation unit 32 sets the amount of the K toner to zero regardless of the set value of the GCR rate, and determines the toner amounts of the CMYKP toners.

FIG. 6 show an aspect in which a combination of the toner amount of each color, in which the amount of the K toner is “0” as CMYKP=(0, 20, 10, 0, 50) is determined, even in a case where the amount of the K toner can be expressed as “10” as CMYKP=(0, 10, 0, 10, 50) for certain Lab values included in the color gamut expanded by the special color toner. As described above, the reason why the amount of the K toner is set to zero in the color gamut using P toner which is a special color toner is that the graininess of the printed image is deteriorated in a case where both of K toner and the P toner are used in combination.

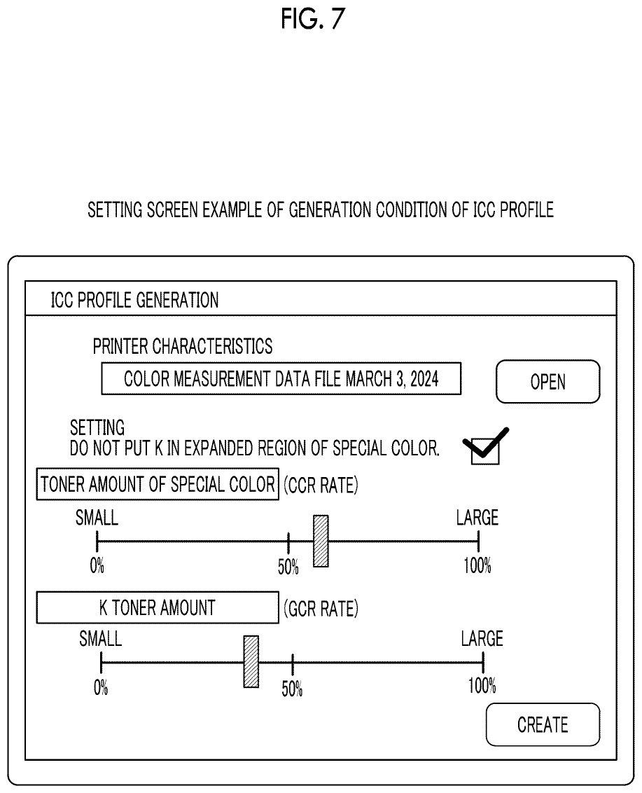

Next, FIG. 7 shows a setting screen example in a case where the generation condition reception unit 31 receives the generation condition of the ICC profile.

In the setting screen example shown in FIG. 7, whether the amount of a special color toner is to be increased or decreased can be set by using a slide bar. In a case where a setting of increasing the amount of a special color toner is performed by using this slide bar, the CCR rate is increased, and in a case where a setting of decreasing the amount of a special color toner is performed by the slide bar, the CCR rate is decreased.

In addition, in the setting screen example shown in FIG. 7, whether the amount of K color toner is to be increased or decreased can be set by using a slide bar. In a case where a setting of increasing the amount of K color toner is performed by using this slide bar, the GCR rate is increased, and in a case where a setting of decreasing the amount of K color toner is performed by the slide bar, the GCR rate is decreased.

In this way, the generation condition reception unit 31 receives the setting of the CCR rate and the GCR rate from the user.

It is noted that in the setting screen example shown in FIG. 7, a check box beside the text “Do not put K in the expanded region of the special color” is selectable, and in a case where this check box is selected, a process of setting the amount of the K toner to zero is executed in a case where the Lab values to be converted are included in the color gamut expanded by the special color toner.

Next, the operation of the ICC profile generation unit 32 in the terminal apparatus 10 according to the present exemplary embodiment will be described in detail with reference to the drawings.

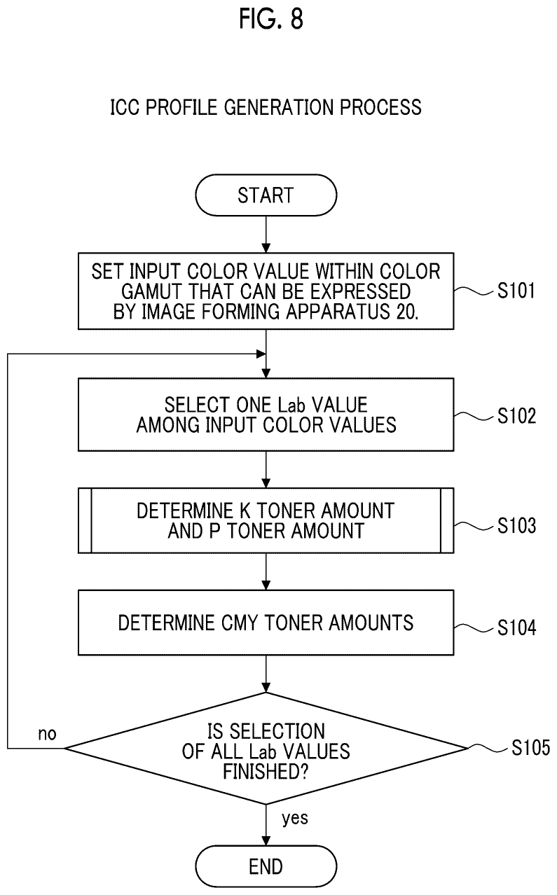

First, the overall operation of the ICC profile generation process in the ICC profile generation unit 32 will be described with reference to a flowchart of FIG. 8.

First, in step S101, the ICC profile generation unit 32 corrects the input color value to fall within a color gamut that can be expressed by the image forming apparatus 20.

Then, in step S102, the ICC profile generation unit 32 selects one Lab value among the input color values.

Next, in step S103, the ICC profile generation unit 32 determines the amount of the K toner and the amount of the P toner with respect to the selected Lab value.

Further, in step S104, the ICC profile generation unit 32 determines the toner amounts of the CMY toners with respect to the selected Lab value. At this stage, since the amount of the K toner and the amount of the P toner have already been determined, it is possible to uniquely determine a solution by simply converting three-dimensional data which is Lab values into three-dimensional data which is CMY.

Finally, in step S105, the ICC profile generation unit 32 determines whether or not the selection of all the input color values in the color measurement data is finished. In a case where it is determined in step S105 that the selection of all the input color values in the color measurement data is not yet finished, the ICC profile generation unit 32 returns to the process of step S102. In addition, in a case where it is determined in step S105 that the selection of all the input color values is finished, the ICC profile generation unit 32 ends the process.

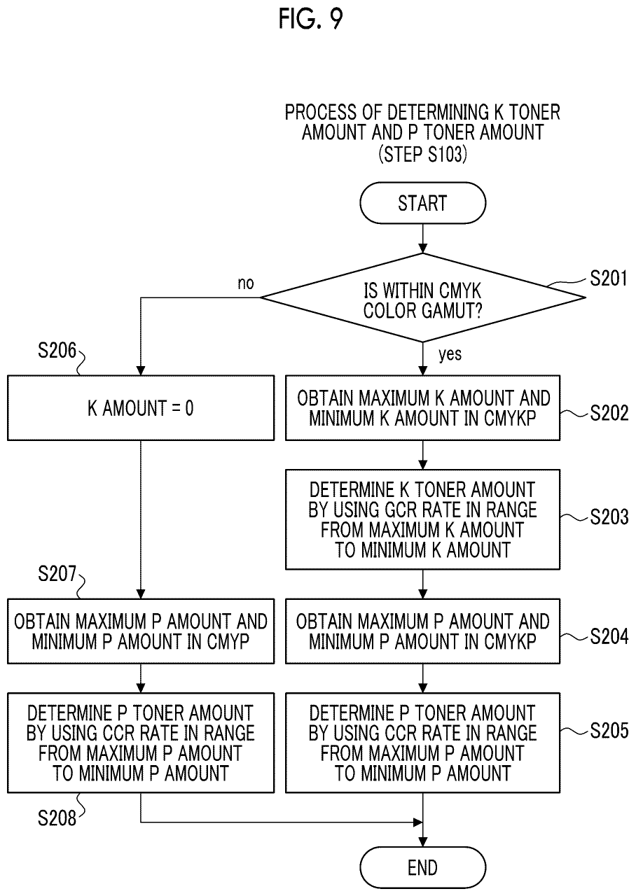

Next, details of the process of step S103, which is the process of determining the amounts of the K toner and the P toner described with reference to the flowchart of FIG. 8, will be described with reference to the flowchart of FIG. 9.

First, in step S201, the ICC profile generation unit 32 determines whether or not the Lab value to be converted is within the range of the CMYK color gamut, that is, whether or not the Lab value is not within the range of the color gamut expanded by the special toner.

In a case where it is determined in step S201 that the Lab values to be converted are within the range of the CMYK color gamut, in step S202, the ICC profile generation unit 32 obtains the maximum value (hereinafter, abbreviated to the maximum K amount) and the minimum value (hereinafter, abbreviated to the minimum K amount) of the amount of the K toner among the combination of the toner amounts that can express the Lab values to be converted by the CMYKP toners.

Moreover, the ICC profile generation unit 32 determines the amount of the K toner by using the GCR rate in a range from the maximum K amount to the minimum K amount, in step S203. Specifically, in a case where the GCR rate is 100%, the ICC profile generation unit 32 determines the maximum K amount as the final amount of the K toner. In a case where the GCR rate is 0%, the ICC profile generation unit 32 determines the minimum K amount as the final amount of the K toner.

Next, in step S204, the ICC profile generation unit 32 obtains the maximum value (hereinafter, abbreviated as the maximum P amount) and the minimum value (hereinafter, abbreviated as the minimum P amount) of the amount of the P toner in the combinations of the toner amounts capable of expressing the Lab values to be converted by the CMYKP toners.

Moreover, in step S205, the ICC profile generation unit 32 determines the amount of the P toner by using the CCR rate in a range from the maximum P amount to the minimum P amount. Specifically, in a case where the CCR rate is 100%, the ICC profile generation unit 32 determines the maximum P amount as the final amount of the P toner. In a case where the CCR rate is 0%, the ICC profile generation unit 32 determines the minimum P amount as the final amount of the P toner.

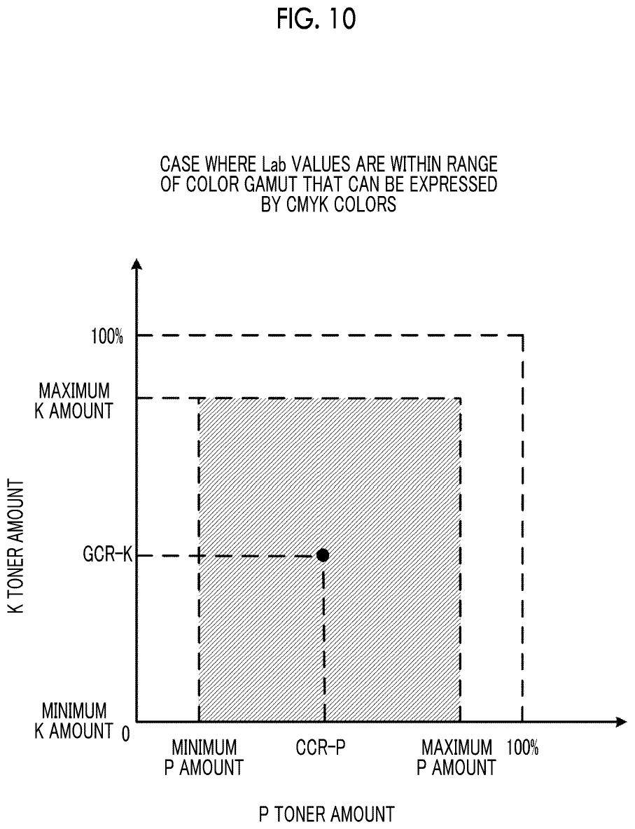

In such a manner, FIG. 10 shows a determination method in a case where the amounts of the K toner and the P toner are determined in a case where the Lab values to be converted are within the range of the color gamut that is expressible by the CMYK colors.

The hatched portion in the graph of FIG. 10 shows a range of K toner amount and the P toner amount with which the Lab value to be converted can be reproduced.

The ICC profile generation unit 32 determines the amount of the K toner based on the GCR rate, in a range of the minimum K amount to the maximum K amount. The amount of the K toner determined in this way is shown as GCR-K in FIG. 10.

Similarly, the ICC profile generation unit 32 determines the amount of the P toner based on the CCR rate, in the range of the minimum P amount to the maximum P amount. The amount of the P toner determined in this way is shown as CCR-Pin FIG. 10.

The GCR-K and the CCR-P determined in this way are the final amounts of the K toner and the P toner, respectively.

Next, in a case where it is determined in step S201 that the Lab value to be converted is out of the range of the CMYK color gamut, the ICC profile generation unit 32 sets the amount of the K toner to zero in step S206.

Next, in step S207, the ICC profile generation unit 32 obtains the maximum P amount and the minimum P amount with respect to the Lab value to be converted.

Moreover, in step S208, the ICC profile generation unit 32 determines the amount of the P toner by using the CCR rate in a range from the maximum P amount to the minimum P amount.

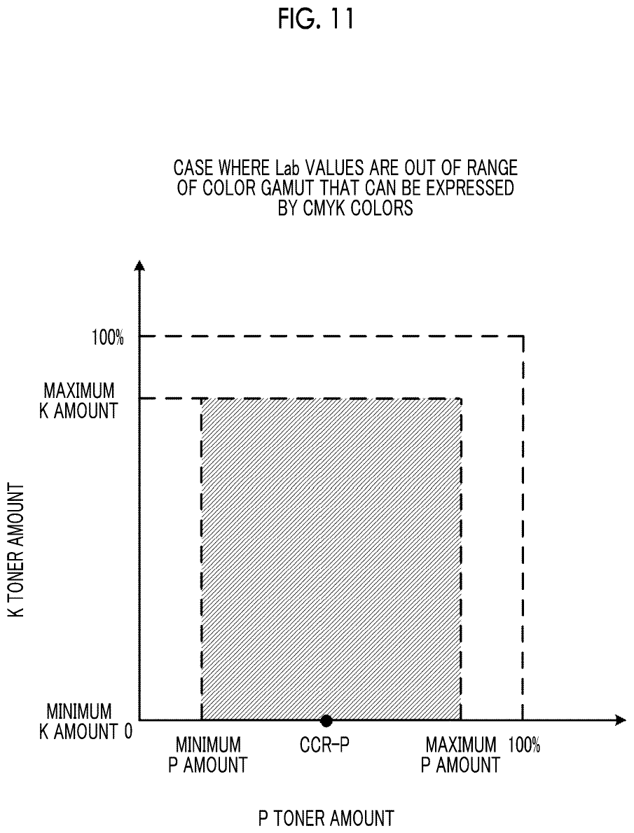

In such a manner, FIG. 11 shows a determination method in a case where the amounts of the K toner and the P toner are determined in a case where the Lab values to be converted are out of range of the color gamut that is expressible by the CMYK colors.

As in FIG. 10, the hatched portion in the graph of FIG. 11 also shows a range of K toner amount and the P toner amount with which the Lab value to be converted can be reproduced.

In this case, the ICC profile generation unit 32 determines the amount of the K toner to be zero, regardless of the set GCR rate.

Moreover, regarding the amount of the P toner, the ICC profile generation unit 32 determines the amount of the P toner based on the CCR rate, in a range of the minimum P amount to the maximum P amount. The amount of the P toner determined in this way is also shown as CCR-P in FIG. 11.

In this manner, the amount of the K toner is determined to be zero, and the CCR-P is determined to be the final amount of the P toner.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The term “system” in the present exemplary embodiment includes both a system configured by a plurality of devices and a system configured by a single device.

### Modification Example

In the exemplary embodiment described above, a case of generating an ICC profile in a case of performing printing using a fluorescent color toner has been described, but the present disclosure is not limited thereto. The present disclosure can be similarly applied to a case of generating an ICC profile in a case of performing printing using a special color toner other than the fluorescent color.

### Supplementary Notes

Hereinafter, aspects of the present disclosure will be described.

(((1)))

An information processing system comprising:
a processor configured to:
   generate profile data in which, in a case of generating the profile data for converting input color values into colorant amounts to be used for printing, in a case where the color values to be converted are out of a color gamut that is expressible by CMYK colors which are basic colors and are within a color gamut that is expressible by a special color other than the basic colors and the basic colors, a colorant amount of each color is determined such that a colorant amount of a colorant of a K color is zero.
      (((2)))

The information processing system according to (((1))), wherein the processor is configured to:
determine a colorant amount of a colorant of the special color based on first rate information indicating a ratio of using a preset colorant amount of the special color.
   (((3)))

The information processing system according to (((2))), wherein the processor is configured to:
determine colorant amounts of the colorants of the remaining CMY colors excluding the determined colorant amounts of the colorants of the K color and special colors to determine colorant amounts of colorants of the basic colors and the special colors corresponding to the color values.
   (((4)))

The information processing system according to any one of (((1))) to (((3))), wherein the processor is configured to:
determine the colorant amount of each color without setting both colorants of the special color and the K color to zero, in a case where the color values to be converted is within the color gamut that is expressible by the CMYK colors which are the basic colors.
   (((5)))

The information processing system according to (((4))), wherein the processor is configured to:
determine a colorant amount of the colorant of the special color based on first rate information indicating a ratio of using a preset colorant amount of the special color; and
determine the colorant amount of the colorant of the K color based on second rate information indicating a ratio of using a preset colorant amount of the K color.
   (((6)))

The information processing system according to any one of (((1))) to (((5))), wherein the special color is a fluorescent color.

(((7)))

A non-transitory computer readable medium storing a program for causing a computer to execute:
receiving an input color value; and
generating profile data in which, in a case of generating the profile data for converting input color values into colorant amounts to be used for printing, in a case where the color values to be converted are out of a color gamut that is expressible by CMYK colors which are basic colors and are within a color gamut that is expressible by a special color other than the basic colors and the basic colors, a colorant amount of each color is determined such that a colorant amount of a colorant of a K color is zero.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a processor configured to:
generate profile data in which, in a case of generating the profile data for converting input color values into colorant amounts to be used for printing, in a case where the color values to be converted are out of a color gamut that is expressible by CMYK colors which are basic colors and are within a color gamut that is expressible by a special color other than the basic colors and the basic colors, a colorant amount of each color is determined such that a colorant amount of a colorant of a K color is zero.

2. The information processing system according to claim 1, wherein the processor is configured to:
determine a colorant amount of a colorant of the special color based on first rate information indicating a ratio of using a preset colorant amount of the special color.

3. The information processing system according to claim 2, wherein the processor is configured to:
determine colorant amounts of the colorants of the remaining CMY colors excluding the determined colorant amounts of the colorants of the K color and special colors to determine colorant amounts of colorants of the basic colors and the special colors corresponding to the color values.

4. The information processing system according to claim 1, wherein the processor is configured to:
determine the colorant amount of each color without setting both colorants of the special color and the K color to zero, in a case where the color values to be converted is within the color gamut that is expressible by the CMYK colors which are the basic colors.

5. The information processing system according to claim 4, wherein the processor is configured to:
determine a colorant amount of the colorant of the special color based on first rate information indicating a ratio of using a preset colorant amount of the special color; and
determine the colorant amount of the colorant of the K color based on second rate information indicating a ratio of using a preset colorant amount of the K color.

6. The information processing system according to claim 1, wherein
the special color is a fluorescent color.

7. A non-transitory computer readable medium storing a program for causing a computer to execute:
receiving an input color value; and
generating profile data in which, in a case of generating the profile data for converting input color values into colorant amounts to be used for printing, in a case where the color values to be converted are out of a color gamut that is expressible by CMYK colors which are basic colors and are within a color gamut that is expressible by a special color other than the basic colors and the basic colors, a colorant amount of each color is determined such that a colorant amount of a colorant of a K color is zero.

8. An information processing method comprising:
receiving an input color value; and
generating profile data in which, in a case of generating the profile data for converting input color values into colorant amounts to be used for printing, in a case where the color values to be converted are out of a color gamut that is expressible by CMYK colors which are basic colors and are within a color gamut that is expressible by a special color other than the basic colors and the basic colors, a colorant amount of each color is determined such that a colorant amount of a colorant of a K color is zero.
